(19) United States
(12) Patent Application Publication
(10) Pub. No.: US 2014/0267166 A1
(43) Pub. Date: Sep. 18, 2014

(54) COMBINED OPTICAL TOUCH AND GESTURE SENSING

(71) Applicant: QUALCOMM MEMS TECHNOLOGIES, INC., San Diego, CA (US)

(72) Inventor: Jonathan C. Griffiths, Fremont, CA (US)

(73) Assignee: QUALCOMM MEMS Technologies, Inc., San Diego, CA (US)

(21) Appl. No.: 13/797,211

(22) Filed: Mar. 12, 2013

(51) Int. Cl. G06F 3/0488

(52) U.S. Cl. CPC G06F 3/0488
USPC 345/175

(57) ABSTRACT

This disclosure provides systems, methods and apparatus for combined optical touch and gesture sensing systems. In one aspect, a bezel surrounding a display surface includes multiple output surfaces which can be configured to direct infrared light both across a device surface to detect touch input and into the area overlying the device surface to detect gesture input. In one aspect, a light-guiding layer having light-turning features can be used to redirect light reflected from an overlying object to photodiodes at the periphery of the device surface. In one aspect, the touch and gesture sensing may be performed in an alternating fashion rather than simultaneously, allowing some components of the combined touch and gesture sensing system to be used in the detection of both touch and gesture.

### TECHNICAL FIELD

This disclosure relates to touch and gesture sensing devices, which can be used in conjunction with or without an underlying display or other electromechanical systems and devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

In displays and in other applications, touch sensors and gesture sensors can be used to provide input or otherwise control an underlying display or other device. Touch sensor systems can be used to sense objects in direct contact with or immediately adjacent an upper surface of a display device or other devices. Gesture sensor systems can be used to sense an object in the area overlying a display, and may not have the accuracy of a touch sensor system. Both touch and gesture sensor systems provide unique ways of interacting with and/or controlling devices.

### SUMMARY

The systems, methods and devices of this disclosure each have several innovative aspects, no single one of which is solely responsible for the desirable attributes disclosed herein.

One innovative aspect of the subject matter described in this disclosure can be implemented in a combined touch-sensing and gesture-sensing system, including a plurality of light-emitting diodes (LEDs) configured to emit infrared (IR) light, a light-directing bezel configured to direct a first portion of the light emitted by the plurality of LEDs in a direction substantially parallel to a device surface, and to direct a second portion of the light emitted by the plurality of LEDs into an area overlying the device surface, a plurality of IR-sensitive photodiodes configured to sense the first and second portions of the emitted light, and a light-directing layer including light-turning features configured to direct a reflected portion of the second portion of the emitted light towards at least a portion of the plurality of IR-sensitive photodiodes.

In some implementations, the bezel can include an input surface adjacent at least a portion of the plurality of LEDs and configured to allow the emitted light to pass into the bezel, a first output surface configured to direct the first portion of emitted light across the display surface, and a second output surface configured to direct the second portion of emitted light into the area overlying the display surface. In at least a first further implementation, the second output surface of the bezel can include a lens structure. In at least a second further implementation, the bezel can also include a light-turning surface configured to redirect light towards the first output surface.

In some implementations, the reflected portion of the second portion of the emitted light can be reflected by an overlying object located in the area overlying the display device. In some implementations, the light-directing layer can be further configured to serve as a portion of an illumination system for a reflective display. In a further implementation, the system can additionally include at least one visible light source configured to emit light into the light-directing layer to illuminate the reflective display.

In some implementations, the plurality of LEDs can include a first subset of LEDs configured to emit the first portion of the light and a second subset of LEDs configured to emit the second portion of the light, where the first subset of LEDs can include a plurality of LEDs located on a first side of the system and a plurality of LEDs located on a second side of the system adjacent the first side. In a further implementation, the second subset of LEDs can include at least one LED located along each side of the system. In a still further implementation, at least one LED located on the first side of the system and at least one LED located on the second side of the system can be part of both the first subset of LEDs and the second subset of LEDs.

In some implementations, the plurality of IR-sensitive photodiodes can include a first plurality of photodiodes configured to sense the first portion of the emitted light and a second plurality of photodiodes configured to sense the second portion of the emitted light. In a further implementation, at least a portion of the first plurality of photodiodes can also form a part of the second plurality of photodiodes.

In some implementations, the system can additionally include a display located on the opposite side of the system as the device surface. In further implementations, the system can additionally include a processor that is configured to communicate with the display, the processor being configured to process image data, and a memory device that is configured to communicate with the processor. In at least a first still further implementation, the system can additionally include a driver circuit configured to send at least one signal to the display, and a controller configured to send at least a portion of the image data to the driver circuit. In at least a second still further implementation, the system can additionally include an image source module configured to send the image data to the processor, where the image source module includes at least one of a receiver, transceiver, and transmitter. In at least a third still further implementation, the system can additionally include an input device configured to receive input data and to communicate the input data to the processor.

Another innovative aspect of the subject matter described in this disclosure can be implemented in a bezel for use in a combined touch-sensing and gesture-sensing system, the bezel including an input surface configured to allow infrared (IR) light to pass into the bezel, first means for directing a first portion of the IR light in a substantially planar manner, and second means for directing a second portion of the IR light at a range of angles relative to the planar output of the first directing means.

In some implementations, the first directing means can include a planar output surface. In some implementations, the second directing means can include a curved output surface. In at least a first further implementation, the curved output surface can be configured to direct the second portion of the IR light in a generally wedge-shaped pattern. In at least a second further implementation, the curved output surface can include a lens structure.

Another innovative aspect of the subject matter described in this disclosure can be implemented in a method of detecting touch and gesture input, the method including emitting infrared (IR) light into an area overlying a device surface, where a first portion of the emitted light is directed in a substantially planar shape over the device surface, and where a second portion of the emitted light is directed into the area overlying the device surface, sensing the first portion of the emitted light which passes across the device surface, sensing the second portion of the emitted light which is reflected off an object overlying the device surface, analyzing the sensed first portion of emitted light to identify a location of an object in contact with or immediately adjacent the device surface, and analyzing the sensed second portion of emitted light to identify a location of an object in the area overlying the device surface.

In some implementations, emitting light into the area overlying the device surface can include emitting light into a bezel located in an area surrounding the device surface, where the bezel includes a first output surface configured to direct the first portion of the emitted light in a substantially planar shape over the device surface, and a second output surface configured to direct the second portion of the emitted light into the area overlying the device surface. In some implementations, the first portion of the emitted light can be emitted at a different time than the second portion of the emitted light.

In some implementations, sensing the second portion of the emitted light can include turning the second portion of the emitted light reflected off an overlying object into a light-guiding layer, and sensing the second portion of the emitted light using at least one photodiode adjacent an edge of the light-guiding layer. In a further implementation, analyzing the sensed second portion of emitted light to identify a location of an object in the area overlying the device surface can include comparing the amounts of the second portion of emitted light which reach photodiodes adjacent each edge of the device surface.

In some implementations, analyzing the sensed first portion of emitted light to identify a location of an object in contact with or immediately adjacent the device surface can include analyzing the sensed first portion of light to identify areas in which the first portion of light is blocked from passing over the device surface.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a top plan view schematically illustrating an example of an infrared (IR) touch sensor system.

FIG. 4A-4C are schematic cross-sectional views of various examples of IR touch sensor systems, taken along the line 4-4 of FIG. 3.

FIG. 5 is a schematic cross-sectional view of another example of an IR touch sensor system including a reflector overlying a beveled edge.

FIG. 6A is a top plan view schematically illustrating an example of an IR gesture sensor system.

FIG. 6B is a schematic cross-sectional view of an example of an IR gesture sensor system, taken along the line 6B-6B of FIG. 6A.

FIG. 6C is a schematic cross-sectional view of an alternate implementation of an IR gesture sensor system.

FIG. 7A is a top plan view schematically illustrating an example of a combined optical touch and gesture system.

FIG. 7B is a schematic cross-sectional view of an example of a combined optical touch and gesture system, taken along the line 7B-7B of FIG. 7A.

FIG. 7C is a schematic cross-sectional view of an example of a combined optical touch and gesture system, taken along the line 7C-7C of FIG. 7A.

FIG. 8 shows an example of a flow diagram illustrating a sensing method using a combined optical touch and gesture system.

FIGS. 9A and 9B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as touch or gesture panels, keypads, or other devices configured to sense touch or gesture input. Thus, the teachings are not intended to be limited to the implementations depicted solely in the Figures, but instead have wide applicability as will be readily apparent to one having ordinary skill in the art.

While many devices include touchscreens or other components configured to sense touch inputs, another possible type of input which can be sensed is gesture input, such as the waving of a hand in the area overlying the display. Gesture inputs may require less precision on the part of the user, and can be used either as a primary input method or as a supplemental input method in addition to touch input. A combined optical touch and gesture sensing system can allow detection of multiple types of input, both direct touch and overlying gestures, via a single system. In addition, by utilizing some common components between the touch and gesture sensing systems, the complexity of the sensing system can be reduced.

Particular implementations of the subject matter described in this disclosure can be implemented to realize one or more of the following potential advantages. In contrast to certain implementations of capacitive touch systems, which may require a dedicated touch sensing layer overlying a display or other device, a combined optical touch and gesture sensing system can be readily integrated into any type of display device or other device. In addition, the use of an optical touch system can reduces certain constraints on touch input relative to capacitive touch systems, which may require skin contact or the use of specific materials in order to register a touch input. Certain embodiments of this invention allow touch and gesture functionality to be tailored independently, while retaining the advantages of a combined touch and gesture system with re-use of common components for optimized product configuration and cost. For example, the sensitivity and resolution of the touch or gesture sensing systems can be optimized independently of each other. Touch and gesture sensing can also be independently controlled, so in a given application, touch and gesture sensing could be used together, or separately, depending on the current requirements of the application. Certain configurations can further maximize system integration advantages. For example, reflective displays often require the use of a front light placed in front of the display to provide supplemental illumination. Some embodiments can be designed to re-use the front light as part of the touch and gesture sensing system, so that a separate light guide is not required.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

Some implementations of devices may include a touch sensor system overlying a display. While some particular implementations may utilize a reflective display such as an interferometric-modulator based display, other implementations may include a less-reflective or non-reflective display, such as a light-emitting diode (LED) or organic LED (OLED) based display, a liquid crystal diode (LCD) based display, or any other suitable display. In addition, other implementations of devices may include a stand-alone sensing system, or a sensing system formed over a static or partially-static image, such as a keypad or other input device. Touch sensor systems can be provided using a variety of different technologies, including infrared (IR) or other optical touch sensors. For convenience, the term infrared (IR) is used herein to describe optical touch sensors and their associated components, as IR-based optical sensors can be used without interfering with the appearance or output of a display, but in other implementations, visible light and light of other wavelengths may also be used.

An IR-based touch system may be configured to direct light in a sheet across a surface such as a front surface of a display or other device. In particular implementations, the IR light may be directed in a sheet across the surface by an IR-transmissive bezel extending around the edges of the display device. IR light emitting diodes (LEDs) may be disposed along two adjacent edges of a rectangular display, within or underneath the bezels, and IR-sensitive light sensors may be disposed along the other two edges, such that IR light is directed from the LEDs, across the screen, and eventually towards IR-sensitive photodiodes where the light is sensed.

FIG. 3 is a top plan view schematically illustrating an example of an infrared (IR) touch sensor system. The touch system 100 includes light sources which may include a plurality of IR light-emitting diodes (LEDs) 130 disposed along two edges of the system 100. The IR LEDs 130 are located within a peripheral region 120 of the system 100 which surrounds a central region 110 of the system. In some implementations, the peripheral region 120 of the system may include a bezel described in greater detail below, and the central region 110 may overlie a display or similar device, so that touch input can be provided to the underlying display or device without obstructing the display or device, using the components disposed in the peripheral region 120 of the system 100 while the central region 110 remains unobstructed. In addition, although the region 120 is described as peripheral, it may not extend to the edge of the system 100, and additional components, such as a device housing, buttons, or other components of system 100 may be disposed outward of the peripheral region 120. Light sensors, which may include IR-sensitive photodiodes 140, are disposed along the other two sides of the system 100. In the illustrated implementation, the same numbers of IR LEDs 130 and photodiodes 140 are provided, but any suitable number of LEDs 130 and photodiodes 140 may be used in other implementations.

The IR LEDs 130 and photodiodes 140 may be connected to or otherwise in electrical communication with control circuitry (not shown), which in some implementations may be discrete control circuitry, and in other implementations may be control circuitry configured to control an underlying device or display. The control circuitry may control the operation of LEDs, and may sense, analyze, and otherwise process output signals from the photodiodes 140. In some particular implementations, the circuitry may include analog/digital converters in electrical connection with the photodiodes 140.

The IR LEDs 130 are configured to emit light across the surface of the central region 110 and towards photodiodes 140 located on the opposite side. As can be seen in FIG. 3, the light 132a emitted by the IR LED 130a reaches the opposing photodiode 140a without obstruction. Because the photodiode 140a will detect an expected amount of IR light from the IR LED 130a, no touch input in the region between the LED 130a and photodiode 140a is registered. In contrast, light 132b emitted by the IR LED 130b will not reached the opposing photodiode 140b, due to obstruction by an object 190 which is either in contact with the underlying surface of device 100 or sufficiently close that the IR light 132b is blocked. Because the photodiode 140b will not detect an expected amount of IR light from the IR LED 130b, a touch input is registered in the region between the LED 130a and photodiode 140a.

Thus, the photodiodes 140 arranged on a first side of the system 100 may be used to identify the location of one or more touch inputs along an axis parallel to the first side of the system 100. The photodiodes 140 along an adjacent second side of the system 100 extending generally perpendicular to the first side of the system 100 may be used to identify the location of one or more touch inputs along an axis parallel to the second side of the system 100 and generally perpendicular to the first side of the system 100.

Different arrangements of the IR LEDs 130 and photodiodes 140 within the peripheral region 120 of the system 100 can be provided. FIGS. 4A and 4B are schematic cross-sectional views of various examples of IR touch sensor systems, taken along the line 4-4 of FIG. 3.

In FIG. 4A, the IR LEDs 130 and photodiodes 140 are located on the same side 104 of an upper substrate 102 of the system 100A that the light 132 is directed over. The system 100A also includes display 112 such as a reflective display, or other object, which is disposed on the opposite side 104 of the substrate 102. While illustrated and referred to for convenience as a single layer, the substrate 102 may in some implementations include a plurality of films, layers, or plates, including frontlight systems, optical processing layers such as diffusers, and other layers as discussed in greater detail herein. The display 112 may include a reflective display, such as an interferometric modulator-based display.

The IR LEDs 130 and photodiodes 140 may be disposed beneath or within a bezel 122 within the peripheral region 120 of the system 100A. The bezel 122 may extend around the periphery of the device 110, or may include discrete bezel sections located. In implementations in which at least one of the IR LEDs 130 and photodiodes 140 are disposed within the bezel 122, at least the portions of the bezel 122 located between the IR LEDs 130 and photodiodes 140 are transmissive to the light 132 emitted by the LEDs 130. In addition, the bezel 122 may include light-shaping or light-shielding structures, such as parabolic or similarly-shaped reflectors, to direct the light 132 primarily across the surface 104 of the device, such as within one millimeter of the surface 104.

The IR LEDs 130 and photodiodes 140 can be connected either directly to sensing and processing circuitry, or can be connected by vias (not shown) extending through the substrate 102. The system 100A may also include additional components not specifically shown in the schematic illustration of FIG. 4A.

In FIG. 4B, the IR LEDs 130 and photodiodes 140 are located on the side 106 of substrate 102 opposite the side 104 of the system 100B that the light 132 is directed over. The bezel 222 of system 100B includes an angled surface 224 that reflects light 132 incident from the IR LEDs 140 through the substrate 102 outward across the surface 104. Light 132 that is not blocked by a finger, stylus, or other object is then turned down towards the photodiodes 140 which can be used to determine whether or not an object has interrupted the light 132. When photodiodes 140 fail to detect light 132, or detect a decrease in the intensity of light 132, this deviation from the expected measured amount of light 132 can indicate an object has interrupted the light 132.

Other implementations can include a combination of the features of FIGS. 4A and 4B. For example, IR LEDs 130 and photodiodes 140 can be located on the upper surface 104 of substrate 102 but still underlie angled bezels such as those of FIG. 4B. In other implementations, the IR LEDs 130 can be located on the opposite side of the substrate 102 as the photodiodes 140, and an angled bezel may overlie only the components which are located on the lower side 106 of the substrate 102.

In the implementation of FIG. 4B, the angled surface may not include a reflective coating or other reflective structure, and the light may be turned via total internal reflection, so long as the index of refraction of the bezel material is greater than that of the adjacent material (such as air). In other implementations, however, a reflective layer or other coating may be provided to ensure that light incident upon the angled surface is turned out over the surface of the substrate.

Although the IR LEDs 130 and photodiodes 140 are shown in FIG. 4B as being supported by or secured to the lower side 106 of the substrate 102, in other implementations one or both of the IR LEDs 130 and photodiodes 140 may be supported by or secured to another component of the system. FIG. 4C shows an example of an IR touch sensor system 100C in which both the IR LEDs 130 and photodiodes 140 are located on an underlying component of the system 100C such as printed circuit board (PCB) 108. The IR LEDs 130 and photodiodes 140 underlie the bezel 222, and positioned such that light 132 emitted from the IR LED 130 is directed by reflector 226 across the upper surface 104 of substrate 102 before being turned back down and received by photodiode 140 if not interrupted by a touch input.

In the illustrated implementation, in which the bezel 222 has an angled surface 224 beveled at roughly a 45° angle, the IR LEDs 130 and photodiodes 140 are located directly under the angled surface 224, but in other implementations in which the bezel 222 has an angled surface 224 beveled at a larger or smaller angle, the IR LEDs 130 and photodiodes 140 may be positioned in slightly different locations which may not directly underlie the angled surface 224.

Although illustrated as spaced apart from the lower surface 104, the IR LEDs 130 and photodiodes 140 may in some implementations be much closer to or even in contact with the substrate 102, even though they are supported by PCB 108 and in electrical communication with electrical circuitry or other electronic components (not shown) on or within PCB 108. In some implementations, PCB 108 may also support control circuitry for controlling the IR LEDs 130 and photodiodes 140 and measurement and/or processing circuitry for measuring and/or processing output signals from the photodiodes 140.

In some implementations, a single PCB 108 may support all of the IR LEDs 130 and photodiodes 140. In some implementations, the PCB 108 may be generally rectangular as shown, and extend beyond the edges of the display 112. In other implementations, the PCB 108 may have at least one aperture extending through an interior region of the PCB 108, and in a particular implementation may be annular with an aperture larger than the display 112, allowing the PCB 108 to extend around the periphery of the display 112 to reduce the thickness of the system 100C. In some implementations, multiple PCBs 108 may be provided. For example, one PCB 108 may be located along each side of the system 100C. In some implementations, only a portion of the IR LEDs 130 or photodiodes 140 may be supported by an underlying PCB 108, while the remaining portion of the IR LEDs 130 or photodiodes 140 may be supported by substrate 102. For example, the PCB 108 may support only the IR LEDs 130 while the photodiodes 140 are supported by substrate 102, or vice versa. Such an arrangement may be utilized, for example, when the photodiodes 140 are thin-film transistor (TFT) photosensors or other photosensitive components formed via TFT or other processes. By forming the photodiodes 140 on the same surface as the display 112, part or all of the photodiodes 140 can be formed at the same time as the display elements, and may utilize some of the same materials and processing steps.

FIG. 5 is a schematic cross-sectional view of another example of an IR touch sensor system including a reflector overlying a beveled edge. The system 200 of FIG. 5 is similar to the system 100C of FIG. 4C, except that the system 200 includes a reflective layer 226 extending adjacent the angled surface 224 of bezel 222. The reflective layer 226 need not necessarily be a layer which is reflective at all angles, but may in some implementations be a material which has a sufficiently low index of refraction relative to the material of bezel 222 that light emitted from IR LED 130 will be reflected out and over the surface 104 of substrate 102.

Light sensors can also be used to detect objects overlying a display or other device when those objects are not in contact with a surface of the display or sufficiently close for a touch sensing system such as those of FIGS. 3 to 5 to detect. In some implementations, such sensors can utilize light-turning structures found within a frontlight layer, or similar structures.

In some implementations, a display or device may be illuminated from the front, using a frontlight system disposed between the display or device and the viewer. Such a frontlight system may be used, for example, in conjunction with a reflective display such as an interferometric modulator-based display.

A frontlight system may include one or more light-guiding films, layers, or plates through which light can propagate, and one or more light-turning features to direct light out of the one or more light-guiding films, layers, or plates. The one or more light-guiding films, layers, or plates may be referred to generically herein as a light-guiding layer, although multiple films, layers, and/or plates may cooperate to provide or function as a light-guiding layer, and adjacent layers having lower indices of refraction may be provided adjacent light-guiding layers to constrain light propagating within the light-guiding layer. Light can be injected into the light-guiding layer, and light-turning features can be used to reflect light within the light-guiding layer towards the reflective display and back through the light-guiding layer towards a viewer. Until light reaches a light-turning feature, the injected light may propagate within the light guiding layer by means of total internal reflection due to selection of a material for the light-guiding layer which has an index of refraction greater than that of the surrounding layers. Thus, such a frontlight layer allows an illuminating light source to be positioned at a location offset from the display itself, such as at one of the edges of the frontlight film.

In implementation in which a device includes a frontlight layer and a reflective display or other reflective object underlying the frontlight layer, the frontlight layer can be used as part of a gesture sensing system.

FIG. 6A is a top plan view schematically illustrating an example of an IR gesture sensor system. The system 300 includes at least one gesture sensing photodiode 380 disposed along each edge of the system 300, and multiple IR gesture LEDs 370 configured to direct IR light 372 (see FIG. 6B below) into the area overlying the central portion 310 of device 300. The gesture sensing photodiodes 380 and IR gesture LEDs 370 are located within a peripheral portion 320 surrounding the central portion 310

FIG. 6B is a schematic cross-sectional view of an example of an IR gesture sensor system, taken along the line 6B-6B of FIG. 6A. It can be seen in FIG. 6B that the system 300 utilizes a light-guiding layer 350 and light turning features 360 adjacent the upper surface of the light-guiding layer 350. The light-guiding layer 350 and light turning features 360 may form part of a frontlight system in which light is injected from visible light sources (not shown) into the light-guiding layer 350, within which it can propagate until it strikes an angled surface 362 of a light turning feature 360. The light is then reflected downward off of a light turning feature 360 and towards reflective display 112 and back through the light-guiding layer 350 towards a viewer.

However, the optical path travelled by the light emitted by the frontlight system will also be followed substantially in reverse by light reflected by objects 390 overlying the system 300. In particular, light 372 directed into the area overlying central portion 310 of system 300 from IR LEDs (not shown in FIG. 6B) will be reflected by an overlying object 390 such that a portions of the reflected light shown as rays 374a and 374b will be directed downward through the light-guiding layer 350 and off of the reflective display 112. When the rays 374a and 374b pass back through the light-guiding layer 350, they may be turned by light turning features 360 back into the light-guiding layer 350, where it will propagate to the edge of the light-guiding layer 350 by total internal reflection. Some of the reflected light will reach gesture photodiodes 380 which may be directly adjacent the edge of light-guiding layer 350 as shown, or spaced apart from the edge of light-guiding layer 350 in other implementations.

Although light turning features 360 are schematically illustrated as large relative to the other components to illustrate the light paths throughout system 300, the light turning features 360 may be much smaller and more numerous, such that they are not readily distinguishable by a viewer and provide even illumination across the frontlight. In some implementations, the light turning features 360 are regularly distributed, while in other implementations they may be distributed in patterns of varying density. In some implementations, the light-turning features 360 may have a symmetric shape, such as a frustroconical shape, while in other implementations the light-turning features 360 may be asymmetrical or otherwise designed to turn light in particular directions.

For sufficiently large numbers of the light turning features 360, portions of the light reflected by an object 390 overlying device 300 are turned towards each of the gesture photodiodes 380, with the amount of reflected light being indicative of the distance between the overlying object 390 and the gesture photodiodes 380. The relative intensity of the light incident upon the gesture photodiodes 380 can therefore be used to identify the presence of and location of an overlying object 390, as well as the height of the overlying object 390.

In the implementation of FIG. 6B, the light-guiding layer 350 is not the upper surface of the system 300, which also includes an overlying layer or layers 308. Similarly, a substrate 102 and additional layers may be disposed between the light-guiding layer 350 and reflective display 112 as discussed previously.

In some implementations, a gesture sensing system such as that of FIGS. 6A and 6B can be implemented in a device without a frontlight system, such as a device without an underlying reflective component such as reflective display 112. Such a gesture sensing system could be used, for example, in conjunction with other types of displays which are less reflective, such as emissive displays, or as part of a standalone sensing panel without an underlying component. In such an implementation, a light-guiding layer such as light-guiding layer 350 of FIG. 6B can be utilized in conjunction with light-turning features which are similar in structure to the light-turning structures 360 of FIG. 6B but positioned adjacent or extending into the lower surface of the light-guiding layer and oriented in the opposite direction. Such oppositely-oriented light-turning structures will turn a portion of light reflected from an overlying object into the light-guiding layer on the first pass through the light-guiding layer, without the need to reflect off an underlying reflective component before being turned.

As described above with respect to FIG. 4C, in some implementations, the gesture photodiodes 380 or other photosensitive components may in some implementations be located not adjacent an edge of the light-guiding layer 350, but on the opposite side of the substrate 102 from the light-guiding layer 350. FIG. 6C is a schematic cross-sectional view of an alternate implementation of such an IR gesture sensor system. In the system 300C of FIG. 6C, a bezel 322 having a beveled reflective surface which may or may not include a reflector 326 is be positioned adjacent an edge of the light-guiding layer 350. The reflector 326 adjacent the beveled edge of the bezel 322 turns light ejected from the light-guiding layer 350 downwards and through substrate 102 to the gesture photodiodes 380 on the opposite side of the substrate 102 as the light-guiding layer 350.

In the illustrated implementation, the gesture photodiodes 380 are shown formed on the lower surface 106 of the substrate 102, and may include either photodiodes secured to the substrate 102 or light-sensitive circuitry formed on the lower surface 106 of the substrate 102 as discussed above. In other implementations, the gesture photodiodes 380 may be supported by one or more underlying PCBs, as discussed with respect to FIG. 4C.

In some implementations, there may be a plurality of gesture photodiodes 380 along each side of the system, instead of a single gesture photodiode 380 along each side of the system as depicted in FIG. 6A. In such an implementation, the accuracy of the gesture sensing system 300C can be increased with increased numbers of gesture photodiodes 380. In an implementation in which the gesture photodiodes 380 are replaced with arrays of photodiodes or other photosensitive circuitry extending along the edges of the system, the intensity of light measured at the various photodiodes may be analyzed to provide an indication of the pattern of light incident upon the light-guiding layer 350 and turned into the light-guiding layer 350 by the light-turning structure 360. Given sufficient numbers of photodiodes 380 along at least two edges of the system, or along each edge of the system, such an implementation of the system 300C may function as a lensless camera. In some implementations, the arrays of photodiodes may be linear arrays, but in other implementations, the arrays of photodiodes may include more than one row of photodiodes extending along the edge of the system. In some implementations, the arrays of photodiodes may include roughly ten rows of photodiodes, with the number of photodiodes in the rows depending on the length of the edge of the system and the size and density of the photodiodes.

In a further implementations, a system configured to function as a lensless camera may utilize a light-turning layer similar to light-guiding layer 350 in which the light-turning structures 360 have the opposite orientation as that shown in FIG. 6C. In such implementations, light-turning structures may be located in or adjacent the lower surface of the oppositely-oriented light-guiding layer and may be configured to turn light into the oppositely-oriented light-guiding layer as the light passes downward through the oppositely-oriented light-guiding layer. This oppositely-oriented light-guiding layer may be in place of or in addition to the light-guiding layer 350 of FIG. 6C. A system including such an oppositely oriented light-guiding layer can be used in conjunction with arrays of photodiodes or other light-sensitive circuitry, such as TFT photosensor arrays, to provide a lensless camera which does not require the sensed light to be reflected off of, and possibly affected by, an underlying reflective display or other reflective object which could affect the pattern of light sensed by the photosensor arrays.

In a particular implementation, a lensless camera system may be provided which includes a light-turning layer which is similar in structure to the light-guiding layer 350 of FIG. 6C but having the opposite orientation. The lensless camera system may also include one or more arrays of light sensors such as TFT photodiodes, which may be formed on the opposite side of a substrate as the light-turning layer. One or more bezels, which may include reflective layers overlying a beveled surface of the bezel, may be used to redirect light ejected from the light-guiding layer through the substrate and towards the one or more arrays of light sensors, where the light can be measured and processed to provide an image of the light incident upon the lensless camera system. Such a lensless camera system may be disposed over a display to provide an indication of the pattern of light incident upon the display, or may be used independent of an underlying display to provide a planar lensless image sensor.

In some implementations, light-turning structures oriented in the opposite direction as those shown in FIGS. 6B and 6C can be used as part of a device which also includes a frontlight system, by using two optically isolated light-guiding layers, with the first light-guiding layer forming part of the frontlight system, and the second light-guiding layer being used as part of a gesture sensing system to redirect light towards gesture photodiodes. To avoid interference between the two systems, the oppositely-oriented light-guiding layer may be disposed between the frontlight system and the viewer. The oppositely-oriented light guiding layer may also be separated from the light-guiding layer of the frontlight system by a layer having a lower index of refraction than the two light-guiding layers to optically isolate the two light-guiding layers from one another.

In some implementations, an optical sensing system may include both an IR touch sensing system and an IR gesture sensing system as described above. FIG. 7A is a top plan view schematically illustrating an example of a combined optical touch and gesture system. The device 400 includes IR touch LEDs 430 and touch photodiodes 440 which cooperate to provide a touch sensing system as discussed above with respect to FIGS. 3-5. The device 400 also includes IR gesture LEDs 470 and gesture photodiodes 480 which cooperate with a frontlight layer (see FIGS. 7B and 7C) to provide a gesture sensing system as discussed above with respect to FIGS. 6A and 6B.

FIG. 7B is a schematic cross-sectional view of an example of a combined optical touch and gesture system, taken along the line 7B-7B of FIG. 7A. IR touch LED 430, touch photodiode 440, and gesture photodiodes 480 are all disposed on the same side 406 of the substrate 102 as the reflective display 112. Although illustrated as being supported by the lower side 406 of the substrate 102, one or more of the IR touch LED 430, touch photodiode 440, and gesture photodiodes 480 may alternately be supported by an underlying component such as a PCB as described above with respect to FIG. 4C. The device 400 includes a bezel 422 on the upper side 104 of substrate 102 within the peripheral region 420 of the device 400.

In the illustrated implementation, the portions of bezels 422 shown in cross-section include angled surfaces 424 which redirect light 432 emitted by IR touch LED 430 through a generally planar output surface 426 of the bezel 422 and over the upper surface 308 of the device 400, and then down to touch photodiode 400. In addition, light 472 emitted from IR gesture LEDs 470 (see FIGS. 7A and 7C) is reflected off an overlying object 490 and turned into light guiding layer 350 after being reflected off of reflective display 112. The angled surfaces 424 of bezels 422 also redirect light 474 as it exits the display, down towards gesture photodiodes 480. In some implementations, gesture photodiodes 480 may be larger in at least one dimension than touch photodiodes 440 because the light 474 may exit light-guiding layer 350 at a wider range of angles than light 432 will be redirected. In other implementations, gesture photodiodes 480 or touch photodiodes 440 may be arrays of photodiodes instead of single photodiodes.

In some implementations, the angled surfaces 424 may be a single contiguous angled surface as illustrated at least within the sections of the bezel 422 overlying both a gesture photodiode 480 and one of an IR touch LED 430 or a touch photodiode 440. In other implementations, the bezel 422 may include two separate surfaces, with one surface configured to direct light to or from touch sensor components such as IR touch LED 430 or a touch photodiode 440, and the other surface configured to redirect light to gesture photodiodes 480. In some implementations, these angled surfaces may be laterally displaced from one another to increase the isolation between light paths for the touch sensing system and the light paths for the gesture sensing system. In some implementations, the angled surfaces may be oriented at angles to one another, which may again be used to increase the isolation between the touch and gesture light paths. In other implementations, two beveled surfaces oriented at different angles may allow the touch and gesture sensing light paths to cross one another allowing greater flexibility in the placement of the touch and gesture IR LEDs and photodiodes.

In some implementations, at least one of the IR touch LED 430, touch photodiode 440, and gesture photodiodes 480 may be disposed on the upper side 104 of substrate 102. For example, the bezel 422 may be much thinner and the angled surface 424 may be dimensioned and located to only direct light 432 from the IR touch LED 430 to the touch photodiode 440. In such an implementation, the gesture photodiode 480 may be located on the upper side 104 of the substrate 102 adjacent an outer surface of the bezel 422, such that the light 472 passing out of the light-guiding layer 350 is passed to the gesture photodiodes 480 without being redirected through the substrate 102. In some such implementations, the outer surface of the bezel 422 may be a substantially vertical face, but other shapes are possible. Similarly, in some such implementations, the gesture photodiode 480 may be located adjacent a generally planar section of the outer surface of the bezel 422, while in other implementations the outer surface of the bezel 422 may include a notch or other feature to accommodate a gesture photodiode. A wide variety of other configurations are possible, and the bezel 422 may be shaped and dimensioned to redirect or pass both touch-sensing light 432 and gesture-sensing light 474 to and from the appropriate components.

FIG. 7C is a schematic cross-sectional view of an example of a combined optical touch and gesture system, taken along the line 7C-7C of FIG. 7A. In the cross-section of the device 400 shown in FIG. 7C, it can be seen that IR gesture LEDs 470 are also located on the same side 106 of the substrate 102 as the reflective display 112. As discussed above, the IR gesture LEDs 470 may alternately be supported by an underlying component such as a separate PCB. The portion of bezel 422 overlying the IR gesture LEDs 470 includes a curved output surface 428. In contrast to the output surface 426 (see FIG. 7B) which is configured to allow light 432 to pass therethrough in a substantially narrow plane, the curved output surface 428 is configured to distribute light emitted by the IR gesture LEDs 470 in a desired pattern schematically illustrated in FIG. 7C by light 472 spreading in an arc or wedge-shaped pattern. In some implementations, the curved output surface may include a lens or other optical structure configured to shape the light passing therethrough. Although the light 472 is illustrating as being spread within the plane of the page, the curved output surface 428 will also spread the light into and/or out of the page. By spreading the light output from IR gesture LEDs 470, the area overlying the central region 410 of the display can be blanketed with IR light, such that any objects entering the area overlying the central region 410 will reflect IR light downwards where it can be turned into the light-guiding layer 350 and directed to gesture photodiodes 480.

The implementation illustrated in FIGS. 7A-7C shows one possible configuration of the touch and gesture LEDs 430 and 470 and of the touch and gesture photodiodes 440 and 480, although a wide variety of other configurations are possible. In some implementations, IR gesture LEDs may be disposed at the corners of the peripheral section 420 of the device 400, where touch LEDs 470 and touch sensors 480 are not positioned. In some implementations, all or a portion of the LED and photodiode components can be disposed over the upper surface 104 of substrate 102, as discussed above. In some implementations, an LED or photodiode may be positioned in substantially the same position when viewed from above as in FIG. 7A, but may be located directly under the bezel 422, rather than on the opposite side of the substrate 102 as the bezel 422.

In some implementations, the bezels 422 located on each side of the device may have a substantially constant cross-section over the length of the bezel, and the constant cross-section may include both a first output surface configured to direct light in a substantially planar shape across the surface of the display 400 and a second output surface configured to spread light in an arc or wedge-shaped pattern into the area overlying the surface of the display 400, as well as any additional input surfaces and light-redirecting surface configured to emit light in one or both directions. In other implementations, the bezel 422 may have a cross-sectional shape that varies over the length of the bezel 422, as depicted in FIGS. 7B and 7C and need not include each of the first output surface, second output surface, input surfaces, and light-turning surfaces described above along the entire length of the bezel 422.

In some implementations, the bezels 422 located on each side of the display 400 may differ in shape from one another. For example, certain bezels or bezel sections which are configured to output touch illumination from IR touch LEDs 430 may differ in shape from other bezels or bezel sections which are configured to turn touch illumination towards touch photodiodes 440. Bezels 422 along a longer side of a display 400 may include more curved surfaces 426 such as lenses or other optical structures in order to accommodate more IR gesture LEDs 470 than the bezels 422 along a shorter side of the display 400.

In some implementations, one or both of touch sensing and gesture sensing may be performed periodically. Time-division multiplexing can be used to isolate touch illumination from gesture illumination, and to minimize crosstalk between the touch sensing system and the gesture sensing system. In such implementations, the IR LEDs may be strobed or cycled through, rather than providing constant illumination. For example, the IR gesture LEDs 480 may be illuminated only periodically, and the gesture photodiodes measured or sampled during the periods of IR gesture illumination, and not necessarily measured when the IR gesture illumination is not active. Similarly, the IR touch LEDs may be periodically illuminated, and the touch photodiodes measured or sampled during the periods of IR touch illumination, and not necessarily measured when the IR touch illumination is not active. In some implementations, periodic touch sensing may be alternated with periodic gesture sensing. In some implementations, periodic touch sensing may occur at the same rate as periodic gesture sampling, while in other implementations the sampling rates may differ.

In further implementations, only a subset of the IR touch or gesture LEDs may be sampled at a given time. For example, the IR touch LEDs along a given side may be illuminated in order and all or a portion of the touch photodiodes on the opposing side may be sampled. Similarly, a subset of the IR gesture LEDs

In some implementations, a single LED can be used as both a touch LED and a gesture LED. In such an implementation, portions of the bezel 422 adjacent the combination touch and gesture LED may include both a first output surface configured to distribute a portion of the light emitted from the touch/gesture LED in a planar shape across an upper surface of the device and a second output surface configured to distribute another portion of the light emitted from the touch/gesture LED into the area overlying the device, such as by distributing the light in an arc or wedge shape. In some implementations, only a portion of the LEDs along a specific side of the device may serve as both a touch LED and a gesture LED. In some such implementations, only portions of the bezel adjacent the combination touch/gesture LEDs may include a second output surface such as a lens or similar structure configured to spread light into the area overlying the display.

In some implementations, several IR LEDs may be located along two adjacent sides of the device 400 and used to provide touch illumination. A smaller number of IR LEDs may be located along the other two sides of the device 400 and used in conjunction with a portion of the IR LEDs along the opposing sides to provide gesture illumination.

Similarly, in some implementations, a single photodiode can be used as both a touch photodiode and a gesture photodiode, particularly in implementations in which periodic touch sensing is alternated with periodic gesture sensing. By utilizing time-division multiplexing or otherwise eliminating cross-talk between the touch sensing system and the gesture sensing system, photodiodes can be used to sense both touch input and gesture input, further reducing the number of components in a combined optical touch and gesture sensing system.

FIG. 8 shows an example of a flow diagram illustrating a sensing method using a combined optical touch and gesture system. The method 500 begins at a block 505 where light, which may be IR light, is directed both in a first area across a device surface and into a second area overlying a device surface. As discussed above, the IR light need not be directed in both areas simultaneously, but may be directed in one of the areas at one time, and in the other area at a subsequent time. The touch IR light directed across the device surface may be emitted by a first group of IR LEDs and the gesture IR light directed into the area overlying the device surface may be emitted by a second group of IR LEDs, although there may be partial or total overlap between the two groups of IR LEDs in various embodiments. The direction of IR light into the two areas may be facilitated by a bezel having a first output surface that directs light into, or allows light to pass through and into, the first area across the display, and a second output surface that directs light into, or allows light to pass thought and into, the second area overlying the display.
The method 500 then moves to a block 510 where the light directed across the surface of the display is sensed by a plurality of touch sensors, and light directed off of objects within the area overlying the display is sensed by a plurality of gesture sensors. As discussed above, the sensors may include IR-sensitive photodiodes. There may be partial or total overlap between the touch sensors and the gesture sensors. In some implementations, light reflected off overlying objects is directed to the gesture sensors using a light-guiding layer and light-turning features configured to turn reflected light into the light-guiding layer. As discussed above, the amount of light incident upon each of the touch sensors and the gesture sensors can indicate touch and/or gesture input, respectively.
The method 500 moves to a block 515 where the light sensed by the touch sensors (or a lack of light being sensed) is analyzed to detect touch inputs, and the light sensed by the gesture sensors is analyzed to detect overlying objects. In some implementations, the touch and gesture sensing may be performed simultaneously, although in other implementations as discussed above time division multiplexing or other methods may be used to alternate between touch sensing and gesture sensing. Particularly when the touch sensing and gesture sensing are not performed simultaneously, a portion of the touch sensors may also serve as gesture sensors, and vice versa.

In other implementations, sensing methods may include additional steps not specifically illustrated in FIG. 8 or described above, or may include fewer steps or combine multiple steps into a single step. For example, the touch sensing portions of blocks 505, 510, and 515 may be performed in order, and then the gesture sensing portions of 505, 510, and 515 may be performed in order. In other implementations, only one of the touch or gesture sensing systems may be active at one time. Additional steps not explicitly described here may also be performed as part of the sensing methods.

FIGS. 9A and 9B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 9A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 9A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface b also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A combined touch-sensing and gesture-sensing system, comprising:
a plurality of light-emitting diodes (LEDs) configured to emit infrared (IR) light;
a light-directing bezel configured to direct a first portion of the light emitted by the plurality of LEDs in a direction substantially parallel to a device surface, and to direct a second portion of the light emitted by the plurality of LEDs into an area overlying the device surface;
a plurality of IR-sensitive photodiodes configured to sense the first and second portions of the emitted light; and
a light-directing layer including light-turning features configured to direct a reflected portion of the second portion of the emitted light towards at least a portion of the plurality of IR-sensitive photodiodes.

2. The system of claim 1, wherein the bezel includes:
an input surface adjacent at least a portion of the plurality of LEDs and configured to allow the emitted light to pass into the bezel;
a first output surface configured to direct the first portion of emitted light across the display surface; and
a second output surface configured to direct the second portion of emitted light into the area overlying the display surface.

3. The system of claim 2, wherein the second output surface of the bezel includes a lens structure.

4. The system of claim 2, wherein the bezel also includes a light-turning surface configured to redirect light towards the first output surface.

5. The system of claim 1, wherein the reflected portion of the second portion of the emitted light is reflected by an overlying object located in the area overlying the display device.

6. The system of claim 1, wherein the light-directing layer is further configured to serve as a portion of an illumination system for a reflective display

7. The system of claim 6, additionally including at least one visible light source configured to emit light into the light-directing layer to illuminate the reflective display.

8. The system of claim 1, wherein the plurality of LEDs include a first subset of LEDs configured to emit the first portion of the light and a second subset of LEDs configured to emit the second portion of the light, wherein the first subset of LEDs includes a plurality of LEDs located on a first side of the system and a plurality of LEDs located on a second side of the system adjacent the first side.

9. The system of claim 8, wherein the second subset of LEDs includes at least one LED located along each side of the system.

10. The system of claim 9, wherein at least one LED located on the first side of the system and at least one LED located on the second side of the system are part of both the first subset of LEDs and the second subset of LEDs.

11. The system of claim 1, wherein the plurality of IR-sensitive photodiodes include a first plurality of photodiodes configured to sense the first portion of the emitted light and a second plurality of photodiodes configured to sense the second portion of the emitted light.

12. The system of claim 11, wherein at least a portion of the first plurality of photodiodes also form a part of the second plurality of photodiodes.

13. The system of claim 1, additionally including a display located on the opposite side of the system as the device surface.

14. The system of claim 13, additionally including:
a processor that is configured to communicate with the display, the processor being configured to process image data; and
a memory device that is configured to communicate with the processor.

15. The system of claim 14, additionally including:
a driver circuit configured to send at least one signal to the display; and
a controller configured to send at least a portion of the image data to the driver circuit.

16. The system of claim 14, additionally including an image source module configured to send the image data to the processor, wherein the image source module comprises at least one of a receiver, transceiver, and transmitter.

17. The system of claim 14, additionally including an input device configured to receive input data and to communicate the input data to the processor.

18. A bezel for use in a combined touch-sensing and gesture-sensing system, the bezel comprising:
an input surface configured to allow infrared (IR) light to pass into the bezel;
first means for directing a first portion of the IR light in a substantially planar manner; and
second means for directing a second portion of the IR light at a range of angles relative to the planar output of the first directing means.

19. The bezel of claim 18, wherein the first directing means includes a planar output surface.

20. The bezel of claim 18, wherein the second directing means includes a curved output surface.

21. The bezel of claim 20, wherein the curved output surface is configured to direct the second portion of the IR light in a generally wedge-shaped pattern.

22. The bezel of claim 20, wherein the curved output surface includes a lens structure.

23. A method of detecting touch and gesture input, the method comprising:
emitting infrared (IR) light into an area overlying a device surface, wherein a first portion of the emitted light is directed in a substantially planar shape over the device surface, and wherein a second portion of the emitted light is directed into the area overlying the device surface;
sensing the first portion of the emitted light which passes across the device surface;
sensing the second portion of the emitted light which is reflected off an object overlying the device surface;
analyzing the sensed first portion of emitted light to identify a location of an object in contact with or immediately adjacent the device surface; and
analyzing the sensed second portion of emitted light to identify a location of an object in the area overlying the device surface.

24. The method of claim 23, wherein emitting light into the area overlying the device surface includes emitting light into a bezel located in an area surrounding the device surface, wherein the bezel includes:
a first output surface configured to direct the first portion of the emitted light in a substantially planar shape over the device surface; and
a second output surface configured to direct the second portion of the emitted light into the area overlying the device surface.

25. The method of claim 23, wherein the first portion of the emitted light is emitted at a different time than the second portion of the emitted light.

26. The method of claim 23, wherein sensing the second portion of the emitted light comprises:
turning the second portion of the emitted light reflected off an overlying object into a light-guiding layer; and
sensing the second portion of the emitted light using at least one photodiode adjacent an edge of the light-guiding layer.

27. The method of claim 26, wherein analyzing the sensed second portion of emitted light to identify a location of an object in the area overlying the device surface comprises comparing the amounts of the second portion of emitted light which reach photodiodes adjacent each edge of the device surface.

28. The method of claim 23, wherein analyzing the sensed first portion of emitted light to identify a location of an object in contact with or immediately adjacent the device surface includes analyzing the sensed first portion of light to identify areas in which the first portion of light is blocked from passing over the device surface.
